(19) United States
(12) Patent Application Publication
(10) Pub. No.: US 2006/0112008 A1
(43) Pub. Date: May 25, 2006

(54) System and method for funding a retirement account

(76) Inventor: James E. Rothbart, Beverly Hills, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/284,482

(22) Filed: Nov. 22, 2005

Related U.S. Application Data
(60) Provisional application No. 60/630,341, filed on Nov. 23, 2004.

(51) Int. Cl. G06Q 40/00

(52) U.S. Cl. 705/40; 705/42

(57) ABSTRACT

According to one embodiment of the invention, a method comprises a plurality of operations. A first operation involves the computation of a total amount of purchases made using a payment card. Next, a percentage of the total amount of the purchases is computed and the monetary value is subsequently deposited into a retirement account associated with the payment card.

This application claims the benefit of priority on U.S. Provisional Application No. 60/630,341 filed Nov. 23, 2004, the contents of which are incorporated by reference.

### FIELD

Embodiments of the invention relates to a system and method for funding a retirement account.

### BACKGROUND

Most Americans readily see the benefits of savings for the future. They grasp the value of long-term financial planning. They know the tax-advantaged Individual Retirement Accounts (IRAs) and employer sponsored 401K plans can deliver many years of compound growth, and understand the urgency in funding those accounts while at a young age.

Unfortunately, most people fail to take advantage of these retirement vehicles due to the inability to fund the retirement plan or the lack of discipline. Worse yet, the traditional source of retirement funds, the employer funded pension, has gone into steep decline. Not even employers have been able to set aside monies for retirement. As such, there must be a new mechanism that allocates monies to retirement.

Today, consumers are charged a number of fees for the convenience of using credit and/or debit cards that operate as an alternative to using cash. These credit and/or debit cards are designed to enhance spending power of a consumer and are profoundly consumption oriented. While conventional credit and/or debit cards may offer “reward programs” that provide numerous goods and services options to a cardholder when and if his or her spending and payments using the card reach various levels, these cards fail to provide any mechanism for retirement savings.

### BRIEF DESCRIPTION OF THE DRAWINGS

The invention may best be understood by referring to the following description and accompanying drawings that are used to illustrate embodiments of the invention.

FIG. 1 is an exemplary embodiment of a system adapted for supporting a payment card directed to the funding of a retirement account.

FIG. 2 is a first exemplary flowchart illustrating the process for establishing and funding one or more retirement accounts utilizing the payment card.

FIG. 3 is an exemplary embodiment of an application form for obtaining account information and funding preferences when establishing a retirement account.

FIG. 4 is a second exemplary flowchart illustrating the process for establishing and funding one or more retirement accounts utilizing the payment card.

### DETAILED DESCRIPTION

Embodiments of the invention relate to a system and method for financial institutions issuing a payment card (e.g., credit and/or debit card hereinafter referred to as an “InstantIRA card) to a customer to apply a percentage of qualified or total purchases made using the payment card to fund a retirement account that set up on behalf of a specific individual or individuals. According to one embodiment of the invention, the retirement account may be an Individual Retirement Account (IRA). Of course, it is contemplated that the retirement account may be any type of account used for retirement savings, including a 401K account for example.

In general, any person wanting to save for retirement on his own may open a retirement account such as an Individual Retirement Account (IRA) for example. Every tax year, a certain sum set by federal statute may be deposited in the IRA. According to one embodiment of the invention, every tax year, a predetermined percentage of the total amount of good and services purchased each month using the InstantIRA card will be deposited into a specified retirement account. So, instead of furthering consumption, the monies are deposited automatically and directly into the cardholder's retirement account. The deposit will take place incrementally throughout the year, perhaps as the cardholder pays the monthly card bills up to the maximum amount allowable by law per year.

Although not shown, general guidelines for utilizing a payment card that funds a retirement account for the cardholder or a different individual is described. The general guidelines are described in an itemized format, albeit the order of the format is not critical to the practice of the invention and the invention may be practiced with modification and alteration of any of these guidelines within the spirit and scope of the claims.

(1) A new customer signs up for an InstantIRA™ card using the card for purchases that are totaled as of December 31 of that calendar year.

(2) The cardholder receives a statement in January showing that an IRA account valued at a predetermined percentage (e.g., 2.5%) of the previous year's purchases has been opened in the name of the designated retirement account holder.

(3) At some point, cardholders may be given the option of making an additional contribution up to the maximum allowed by law for the previous calendar year.

(4) The cardholder may allocate moneys, by specific dollar amounts or proportions, toward a menu of fund choices (conservative, growth, index, etc.).

(5) At the time the InstantIRA™ card is issued, the cardholder agrees to keep the retirement account within the issuing institution's family of funds for a set number of years as allowed by law. Bank penalties may be assessed for early withdrawal or transfer to other funds.

(6) The cardholder may designate another family member or dependent to be the recipient of the IRA account; there will be only one IRA per card and award contributions may not exceed the maximum allowed by law.

(7) Additional cards may be issued on the same account to other family members; their contributions may be allocated to the original cardholder's IRA account.

(8) A small maintenance fee is charged each year on existing IRA accounts; customers may elect to have the fee deducted automatically from their IRA or billed to their statement.

(9) Cards may be cancelled by the customer at any time, but an existing IRA account in the customer's name will retain its value.

(10) No new IRA contributions will be made toward card accounts cancelled during any given calendar year or not in good standing as of midnight, December 31.

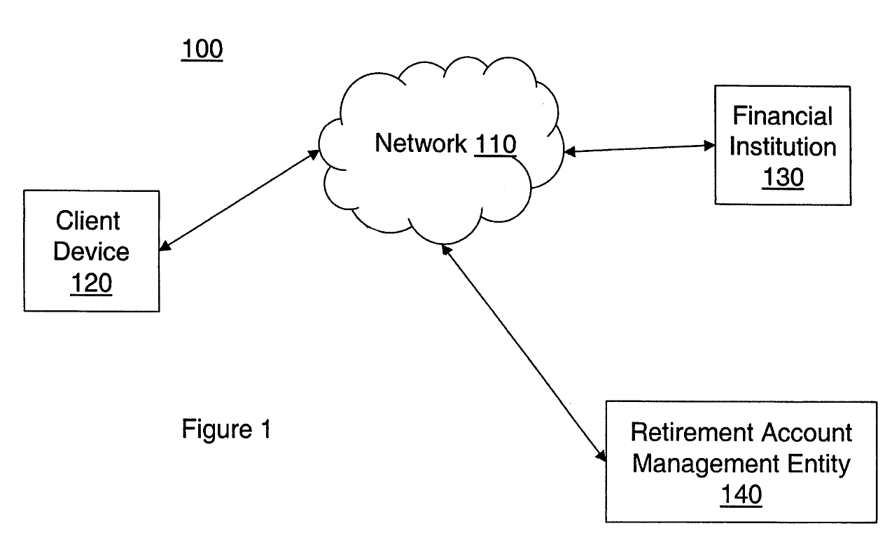

Referring now to FIG. 1, an exemplary embodiment of a system adapted for obtaining an InstantIRA™ card directed to the funding of a retirement account is shown. Herein, system 100 features a wide area network (WAN) 110 such as the Internet that supports communications between one or more client devices 120 and a financial institution 130 issuing a payment card. Client device 120 is an electronic device having access to the WAN 110 and may include, but is not limited or restricted to a computer, a personal digital assistant, a cellular telephone, a set-top box and the like.

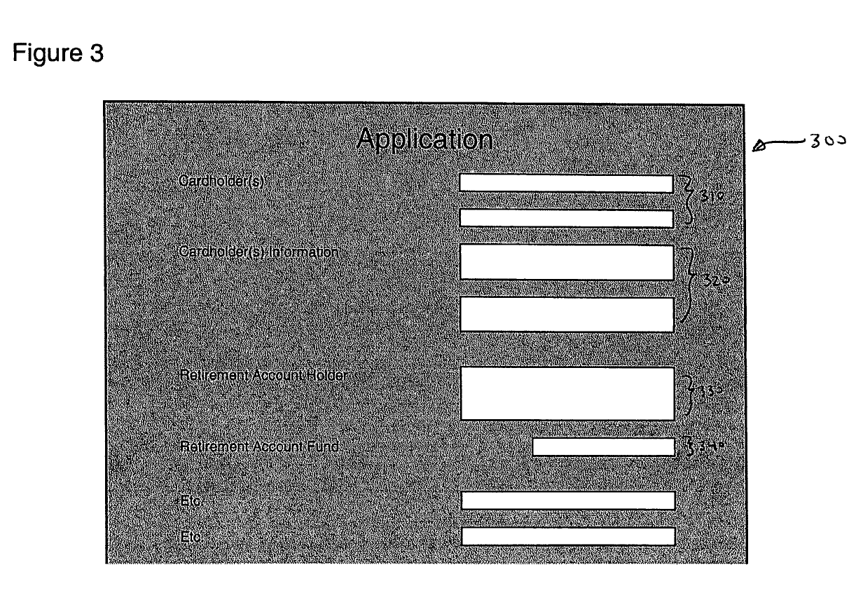

A potential cardholder enters information into appropriate fields of the application and, upon completion, transmits the information to financial institution 130. Financial institution 130 includes one or more servers to process the on-line application form (generally illustrated in FIG. 3), and if accepted, establishes both an InstantIRA™ card account in the name of the cardholder and one or more retirement accounts in the names of one or more of the cardholders or any individual or individuals specified as the recipient of the retirement funding. Where financial institution 130 is capable of managing manage retirement accounts (e.g., Citibank®, Bank of America®, or another banking/investment institution), both accounts may be opened and maintained by computers under the control of financial institution 130. However, when financial institution 130 is not adapted to manage retirement accounts or does not want the responsibility and liability associated with such management, financial institution 130 may operate in concert with a retirement account management entity 140 that is responsible for managing the retirement account(s). Examples of a “retirement account management entity” includes Vanguard® investment services, Fidelity® investment services, and the like.

According to one example, financial institution 130 may be a credit card service provider that handles the credit card transactions and, after each prescribed time period (e.g., month), computes the retirement proceeds for that time period. The “retirement proceeds” constitute the monetary value computed as a percentage of the qualifying or total purchases made with the InstantIRA™ card. The retirement proceeds may be determined and deposited according to any desired time period such as on a monthly, quarterly, semi-annual or annual basis. The retirement proceeds may be transferred to retirement account management entity 140, which handles the deposit of the retirement proceeds into the proper retirement account(s). These retirement account(s) may be funds provided by retirement account management entity 140 or funds provided any separate investment company.

Of course, in lieu of an on-line application, it is contemplated that the application process may involve the InstantIRA™ cardholder to complete a paper application and mail the application to entity 130. Where the application is accepted, the cardholder information is entered into a computer file, an account for the InstantIRA™ card is opened as well as one or more retirement accounts corresponding to the InstantIRA™ account.

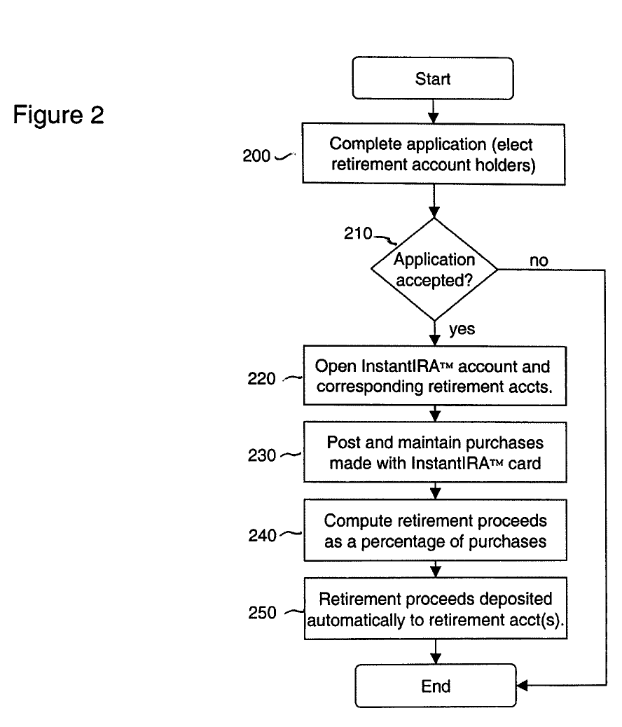

Referring now to FIG. 2, a first exemplary flowchart illustrating the process for establishing and funding one or more retirement accounts utilizing the InstantIRA™ card is shown. Initially, an application is completed and provided to the entity issuing the InstantIRA™ card (block 200). The application will include information concerning the cardholder and the designated retirement account holder.

As shown in FIG. 3, an exemplary embodiment of an application form 300 for obtaining account information and funding preferences when establishing a retirement account is shown. Application form 300 includes a plurality of entries for information including, but not limited or restricted to (i) the name or names of the cardholder(s) 310, (ii) personal information concerning each of the cardholder(s) 320, (iii) the name or names of the designated retirement account holders 330, and (iv) retirement account fund selection 340.

More specifically, the cardholder name(s) 310 identify the party or parties fiscally responsible for credit card charges made using the InstantIRA™ card. For instance, a single adult or multiple adults (e.g., couple) may apply for the InstantIRA™ card and be responsible for charges made with the InstantIRA™ card. Personal information 310, such as residential address, date of birth, social security number and the like, may be solicited for each of the cardholders. Alternatively, where the cardholder is a single adult, it may be possible to request additional InstantIRA™ cards for other members of his or her family without supplying personal information for such persons.

In general, the designated retirement account holders 330 may be one or more of the cardholders. However, it is contemplated that the retirement account holder may be different from any of the cardholders, which would require the name and personal information pertaining to the retirement account holder(s). For instance, a father may list his son and daughter to receive proceeds into retirement accounts set up on their behalf. Where more than one retirement account holder is designated, it is contemplated that the proceeds may be deposited on a percentage basis (where one account holder receives “X” percentage and another retirement account holder receives “100−X” percentage) or in a successive basis (where the retirement account of a first holder is fully funded before a retirement account for another holder is funded). The separation between the cardholder and the recipient of the retirement proceeds provides flexibility so that financially established individuals can save on behalf of family and friends.

The retirement account fund selection 340 identifies a particular fund or funds that receive some or all of the retirement proceeds. These funds may be private funds internally managed or may be publicly available funds.

Referring back to FIG. 2, after the application is completed, accepted and both types of accounts (InstantIRA™ account & retirement account(s)) are opened, the purchases made with the InstantIRA™ card are posted and maintained (blocks 210, 220 and 230). The resultant retirement proceeds are computed (block 240).

For instance, according to one embodiment of the invention, the retirement proceeds may be equivalent to a percentage (2.5%) of the total purchases made with the InstantIRA™ card. As an example, if the cardholder charged $1000 in January 2006, $25 would be computed as the retirement proceeds.

Alternatively, according to another embodiment of the invention, the retirement proceeds may be computed based on a predetermined percentage of qualified purchases, namely purchases from specified vendors or purchases for specified categories of goods or services. As another example, if the cardholder charged $1000 in January 2006 of which $500 was directed to qualified purchases, $12.50 would be computed as the entitled retirement proceeds, presuming a 2.5% retirement funding rate.

Thereafter, at some point in time, the retirement proceeds are deposited into the retirement account(s) corresponding to that InstantIRA™ card (block 250). Of course, as directed, additional payments may be applied as proceeds to the retirement account on a dollar-to-dollar basis.

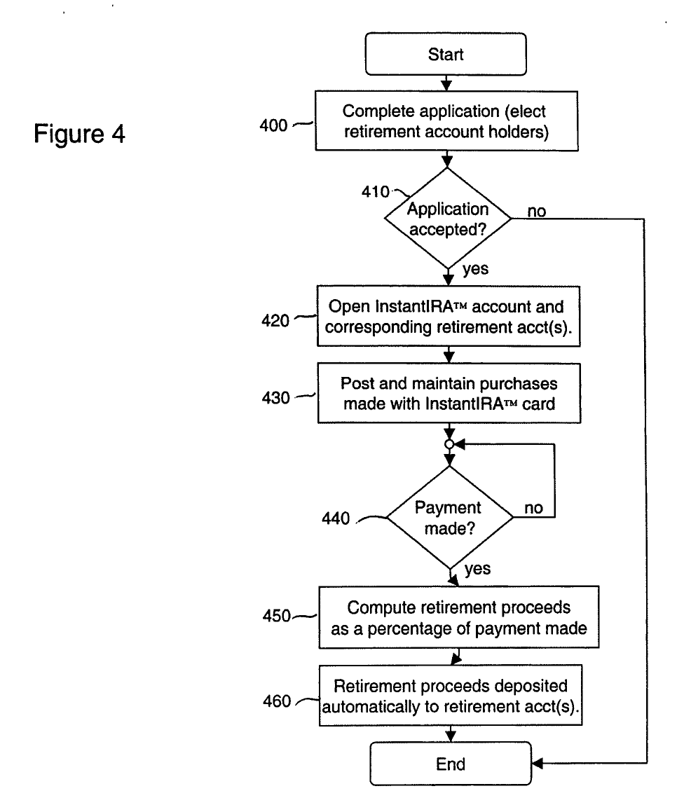

Referring now to FIG. 4, a second exemplary flowchart illustrating the process for establishing and funding one or more retirement accounts utilizing the InstantIRA™ card is shown. Initially, an application is completed and provided to the financial institution issuing the InstantIRA™ card (block 400). After the application is completed, accepted and both types of accounts (InstantIRA™ account & retirement account(s)) are opened, the purchases made with the InstantIRA™ card are credited to the InstantIRA™ account and maintained (blocks 410, 420 and 430).

Once the payment is received from the cardholder, retirement proceeds corresponding to a percentage (2.5%) of the total payments made are computed (blocks 440 and 450). As an illustrative example, if the cardholder charged $1000 in January 2006 and pays $500 on his monthly bill, $12.50 would be computed as the retirement proceeds. Of course, where retirement proceeds may be computed based on a predetermined percentage of qualified purchases, the retirement proceeds may be lower. It is noted that any overpayments may be applied to the retirement account, as directed, on a dollar-to-dollar basis.

Thereafter, at some point in time, the retirement proceeds are deposited into the retirement accounts corresponding to that InstantIRA™ card (block 460).

In general, one embodiment of the invention is the funding of retirement accounts (e.g., IRAs, 401Ks, etc.) based on a percentage of the total purchases (i.e., total monetary amount) made with a certain payment card. While it is generally applicable for use with credit cards, it is contemplated that the invention may be applicable to debit cards where an account is set up at financial institutions and purchases are automatically debited from the monies within the account. To offset the costs, the financial institution may charge appropriate fees (e.g., management, card usage, etc.).

While the invention has been described in terms of several embodiments of the invention, those of ordinary skill in the art will recognize that the invention is not limited to the embodiments of the invention described, but can be practiced with modification and alteration within the spirit and scope of the claims. The description is thus to be regarded as illustrative instead of limiting.

1. A method comprising:
computing a total amount of purchases made using a payment card; and
applying a percentage of the total amount of the purchases to at least one retirement account.

2. The method of claim 1, wherein the at least one retirement account is owned by a person other than an authorized user of the payment card.

3. The method of claim 1, wherein the at least one retirement account includes a plurality of retirement accounts each individually owned by an authorized user of the payment card.

4. The method of claim 1, wherein the at least one retirement account is an Individual Retirement Account (IRA).

5. The method of claim 1, wherein the computing of the total amount of purchases made using a payment card is conducted by a computer and the total amount stored in a database.

6. The method of claim 1, wherein the payment card is a credit card.

7. A method comprising:
computing and maintaining a total amount of purchases made using a payment card, the total amount being a balance of credit for the payment card;
applying a monetary value equal to a percentage of a payment applied to the balance of credit to at least one retirement account.

8. The method of claim 7, wherein the at least one retirement account is owned by a person other than an authorized user of the payment card.

9. The method of claim 7, wherein the at least one retirement account includes a plurality of retirement accounts each individually owned by an authorized user of the payment card, the monetary value applied to a retirement account of a first authorized user of the payment card until a maximum contribution to the retirement account of the first authorized user has been reached, then applying the monetary value to a retirement account of a second authorized user of the payment card.

10. The method of claim 7, wherein the at least one retirement account includes a plurality of retirement accounts each individually owned by an authorized user of the payment card, a first percentage of the monetary value applied to a retirement account of a first authorized user of the payment card and a second percentage of the monetary value applied to a retirement account of a second authorized user of the payment card.

11. The method of claim 7, wherein the at least one retirement account is an Individual Retirement Account (IRA).

12. The method of claim 7, wherein the computing of the total amount of purchases being conducted by a computer and the balance of credit being stored in a database.

13. The method of claim 7, wherein the payment card is a credit card.

14. A system comprising:
a network;
a client device; and
at least one computer controlled by a financial institution in communication with the client device over the network, the at least one computer computing a total amount of purchases made using a payment card and applying a percentage of the total amount of the purchases to a retirement account associated with the payment card.

15. The system of claim 14, wherein the at least one computer is a computerized network.

16. The system of claim 14, wherein the retirement account is owned by a person other than an authorized user of the payment card.

17. The system of claim 16, wherein the retirement account is an Individual Retirement Account (IRA).

18. The system of claim 14, wherein the payment card is a credit card.
